(19) United States
(12) Patent Application Publication
(10) Pub. No.: US 2013/0288170 A1
(43) Pub. Date: Oct. 31, 2013

(54) ELECTROPHOTOGRAPHIC PHOTORECEPTOR, PROCESS CARTRIDGE, AND IMAGE FORMING APPARATUS

(71) Applicant: FUJI XEROX CO., LTD., Tokyo (JP)

(72) Inventors: Yohei SAITO, Kanagawa (JP); Koji BANDO, Kanagawa (JP); Shinya YAMAMOTO, Kanagawa (JP); Masahiro IWASAKI, Kanagawa (JP); Takayuki YAMASHITA, Kanagawa (JP); Jiro KORENAGA, Kanagawa (JP); Yuko YAMANO, Kanagawa (JP)

(73) Assignee: FUJI XEROX CO., LTD., Tokyo (JP)

(21) Appl. No.: 13/713,977

(22) Filed: Dec. 13, 2012

(30) Foreign Application Priority Data
Apr. 27, 2012 (JP) 2012-103987

(51) Int. Cl. G03G 15/00; G03G 21/18

(52) U.S. Cl. CPC G03G 5/0614; G03G 21/18
USPC 430/56; 399/111; 430/58.05; 430/58.5; 430/58.65; 430/58.35; 399/159

(57) ABSTRACT

An electrophotographic photoreceptor includes a conductive substrate; a single-layer photosensitive layer that is provided on the conductive substrate and includes a binder resin, a charge generation material, a hole transport material, and an electron transport material, wherein a half decay exposure during positive charging is less than or equal to 0.18 μJ/cm², and a half decay exposure during negative charging is 2 to 12 times the half decay exposure during positive charging.

### CROSS-REFERENCE TO RELATED APPLICATIONS

This application is based on and claims priority under 35 USC 119 from Japanese Patent Application No. 2012-103987 filed Apr. 27, 2012.

### BACKGROUND

1. Technical Field

The present invention relates to an electrophotographic photoreceptor, a process cartridge, and an image forming apparatus.

2. Related Art

In electrophotographic image forming apparatuses of the related art, a toner image, formed on a surface of an electrophotographic photoreceptor, is transferred onto a recording medium through charging, exposure, developing, and transfer processes.

As a photosensitive layer of an electrophotographic photoreceptor which is used in such an electrophotographic image forming apparatus, for example, configurations using a single-layer photosensitive layer are known.

### SUMMARY

According to an aspect of the invention, there is provided an electrophotographic photoreceptor including a conductive substrate; and a single-layer photosensitive layer that is provided on the conductive substrate and includes a binder resin, a charge generation material, a hole transport material, and an electron transport material, wherein a half decay exposure during positive charging is less than or equal to 0.18 μJ/cm², and a half decay exposure during negative charging is 2 times to 12 times the half decay exposure during positive charging.

### BRIEF DESCRIPTION OF THE DRAWINGS

Exemplary embodiments of the present invention will be described in detail based on the following figures, wherein:

FIG. 1 is a cross-sectional view schematically illustrating a part of an electrophotographic photoreceptor according to an exemplary embodiment of the invention;

FIG. 2 is a diagram schematically illustrating a configuration of an image forming apparatus according to an exemplary embodiment of the invention;

FIG. 3 is a diagram schematically illustrating a configuration of an image forming apparatus according to another exemplary embodiment of the invention;

FIG. 4 is a side view illustrating a configuration of an apparatus for measuring a surface potential of a photoreceptor; and

FIG. 5 is a cross-sectional view taken along line I-I schematically illustrating the apparatus illustrated in FIG. 4.

### DETAILED DESCRIPTION

Hereinafter, exemplary embodiments which are examples of the invention will be described.

### Electrophotographic Photoreceptor

An electrophotographic photoreceptor according to an exemplary embodiment of the invention is a positively charged organic photoreceptor (hereinafter, sometimes referred to as “a single-layer photoreceptor”) which includes a conductive substrate and a single-layer photosensitive layer on the conductive substrate.

The single-layer photosensitive layer includes a binder resin, a charge generation material, a hole transport material, and an electron transport material. In addition, a half decay exposure during positive charging is less than or equal to 0.18 μJ/cm², and a half decay exposure during negative charging is 2 times to 12 times the half decay exposure during positive charging.

The single-layer photosensitive layer has charge generation capability, a hole transport property, and an electron transport property.

In the related art, as an electrophotographic photoreceptor, a single-layer photoreceptor is preferable from the viewpoints of manufacturing cost and image quality stability.

The single-layer photoreceptor has a configuration in which a single-layer photosensitive layer thereof includes a charge generation material, a hole transport material, and an electron transport material. Therefore, it is difficult to obtain the same level of sensitivity as that of an organic photoreceptor having a multi-layer photosensitive layer and higher sensitivity is required.

However, when sensitivity increases in the single-layer photoreceptor, a phenomenon called ghosting occurs in which image history of a photoreceptor in the previous cycle appears in the next cycle. The reason why ghosting occurs is considered to be as follows:

(1) History due to exposure; and

(2) History due to transfer (that is, on a photoreceptor, a non-exposed portion where there is no toner image during transfer has stronger transfer stress than that of an exposed portion where a toner is developed and thus image history appears). In particular, it is considered that, the single-layer photoreceptor, which contains both of an electron transport material and a hole transport material in a photosensitive layer, is easily affected by the transfer stress and thus has a larger amount of (2) the history due to transfer than that of a multi-layer photoreceptor. It is considered that, as sensitivity is lower in the single-layer photoreceptor, a larger charge is generated due to exposure and remains in a photosensitive layer, that is, a larger amount of (1) the history due to exposure appears; and as a result, the histories (1) and (2) are cancelled out to suppress ghosting. However, it is considered that, when sensitivity increases using the single-layer photoreceptor, a smaller charge is generated due to exposure and remains in a photosensitive layer; (1) the history due to exposure is reduced; the balance between the histories (1) and (2) is disrupted; and thus ghosting occurs.

On the other hand, in the electrophotographic photoreceptor according to the exemplary embodiment, a half decay exposure during positive charging is less than or equal to 0.18 μJ/cm², and a half decay exposure during negative charging is adjusted to be 2 times to 12 times the half decay exposure during positive charging; and as a result, the increasing of sensitivity during positive charging and the suppressing of ghosting are simultaneously obtained.

The reason is not clear but is considered to be as follows. That is, even in a photoreceptor in which sensitivity increases during positive charging by setting a half decay exposure during positive charging to be less than or equal to 0.18 μJ/cm², the ratio of half decay exposures during positive and negative charging is adjusted to the above-described range. As a result, a sensitivity during negative charge, which contributes to transfer stress (negative charging), is set to be lower than that during positive charging; (1) the history due to exposure and (2) the history due to transfer are well-balanced; and thus ghosting is suppressed.

An image forming apparatus not having an erasing process may be provided from the viewpoint of manufacturing cost. Specifically, this image forming apparatus does not include an erasing unit that erases an outer peripheral surface of an electrophotographic photoreceptor, in a region which is located downstream of a charging unit and is located upstream of a transfer unit in a driving direction of the electrophotographic photoreceptor. In this image forming apparatus, ghosting occurs more easily because image history of a photoreceptor in the previous cycle is not erased by the erasing unit. However, by using the above-described electrophotographic photoreceptor according to the exemplary embodiment, ghosting is efficiently suppressed.

In addition, an image forming apparatus including a charger (for example, a corotron or scorotron charger) as a charging unit that charges a surface of the electrophotographic photoreceptor without contact therewith, may be provided. When a contact charger (for example, a charger which directly charges a surface of a photoreceptor with a charging roller) is used as the charging unit, performance of erasing image history of a photoreceptor in the previous cycle is superior. Accordingly, when the non-contact charger is compared to the contact charger, ghosting occurs more easily. However, by using the above-described electrophotographic photoreceptor according to the exemplary embodiment, ghosting is efficiently suppressed.

### Half Decay Exposure During Positive Charging

In the single-layer photosensitive layer of the electrophotographic photoreceptor according to the exemplary embodiment, the half decay exposure during positive charging is preferably less than or equal to 0.18 μJ/cm², more preferably less than or equal to 0.14 μJ/cm², and still more preferably less than or equal to 0.11 μJ/cm².

The half decay exposure during positive charging being in the above-described range represents that the sensitivity during positive charging is high. When the half decay exposure during positive charging is greater than the above-described range, the sensitivity during positive charging is reduced, which leads to a deterioration in the quality of an image to be formed, in particular, a deterioration in the density of the image.

### Ratio of Half Decay Exposures During Positive and Negative Charging

In the single-layer photosensitive layer of the electrophotographic photoreceptor according to the exemplary embodiment, the half decay exposure during negative charging is preferably 2 times to 12 times, more preferably 4 times to 10 times, and still more preferably 5 times to 9 times the half decay exposure during positive charging.

When the ratio of the half decay exposure during negative charging to the half decay exposure during positive charging is less than the lower limit, negative ghosting occurs. On the other hand, when the ratio is greater than the upper limit, positive ghosting occurs.

Negative ghosting is a phenomenon in which, for example, when black characters are printed on a white background and then a halftone image is printed on the entire surface, the history of the black characters appears on the halftone image to a slight degree at a pitch of the photoreceptor. On the other hand, positive ghosting is a phenomenon in which, for example, when black characters are printed on a white background and then a halftone image is printed on the entire surface, the history of the black characters appears on the halftone image to a large degree at a pitch of the photoreceptor.

### Method of Measuring Half Decay Exposures During Positive and Negative Charging

A method of measuring half decay exposures during positive and negative charging will be described with reference to the drawings.

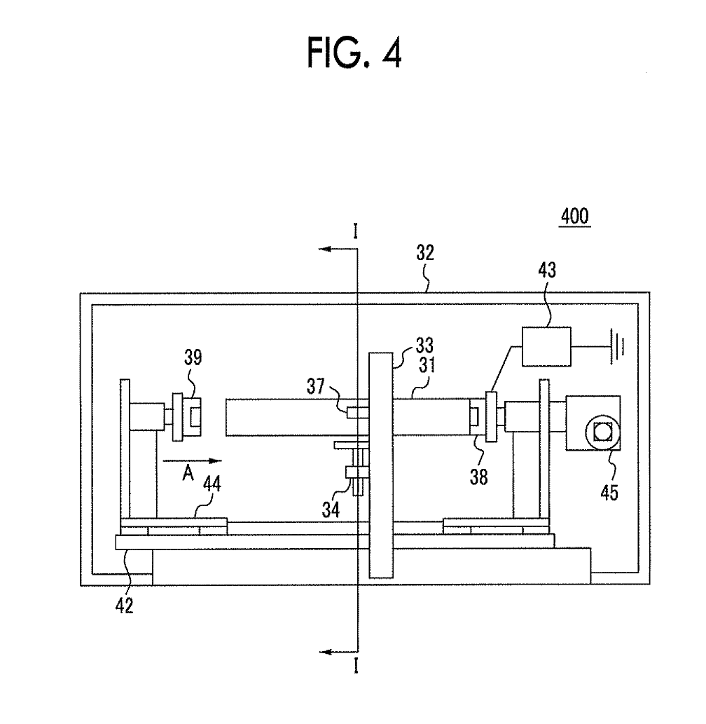

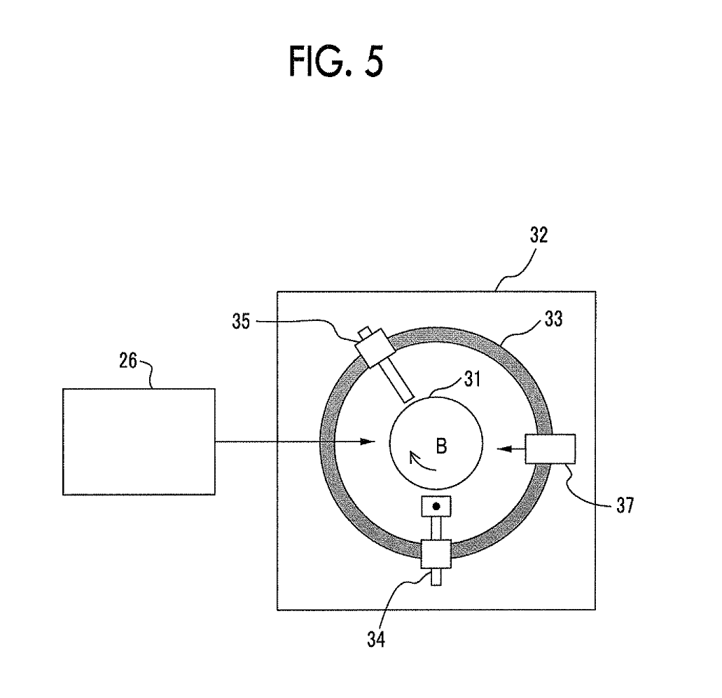

FIG. 4 is a side view illustrating a configuration of an apparatus for measuring a surface potential of a photoreceptor; and FIG. 5 is a cross-sectional view taken along line I-I schematically illustrating the apparatus illustrated in FIG. 4. As illustrated in FIGS. 4 and 5, a photoreceptor 31 as a target for measurement is installed inside a housing 32 of a measuring apparatus 400. In an outer peripheral portion of the photoreceptor 31, a charging device 34, a potential measuring device 35, and an erasing device 37 are installed through an annular attachment member 33 which is fixed to a bottom of the housing 32. An exposure device 26 is installed outside the housing 32.

An end of the photoreceptor 31 is supported by a support portion 38 and the other end of the photoreceptor 31 is supported by a support portion 39 by moving a slide plate 44, in which the support portion 39 is installed, in a direction indicated by arrow A in FIG. 4. The support portion 38 has a structure capable of rotating the photoreceptor 31 in a direction indicated by arrow B in FIG. 5 in cooperation with a rotary motor 45. The rotational speed is arbitrarily set. In addition, a conductive substrate configuring the photoreceptor 31 is connected to a current measuring device 43 through the support portion 38.

In addition, the support portions 38 and 39 and the rotary motor 45 are installed on an automatic stage 42 which reciprocates in an axial direction of the photoreceptor 31. As a result, the photoreceptor 31 may move in the axial direction thereof relative to the charging device 34, the potential measuring device 35, and the erasing device 37 which are attached to the attachment member 33.

In addition, each of the charging device 34, the potential measuring device 35, and the erasing device 37 is attached to the attachment member 33, which may move back and forth in the normal direction of a surface of the photoreceptor 31, so as to be arranged with a gap with the surface of the photoreceptor 31 even when diameters of the photoreceptor 31 are different. Furthermore, each of the charging device 34, the potential measuring device 35, and the erasing device 37 is attached to the attachment member 33 so as to freely adjust the position thereof in a circumferential direction of the photoreceptor 31.

Hereinafter, the respective components of the measuring apparatus 400 will be described.

The charging device 34 charges the photoreceptor 31 and uses a scorotron having an effective charging width of 50 mm in the axial direction of the photoreceptor 31.

The potential measuring device 35 is installed downstream of the charging device 34 in a rotating direction of the photoreceptor 31 and measures a surface potential of the photoreceptor 31 after being charged. The potential measuring device 35 includes a potential measuring probe and a surface potential meter, in which Model 555P-1 (manufactured by TREK JAPAN Co., Ltd.) is used as the potential measuring probe and Model 334 (manufactured by TREK JAPAN Co., Ltd.) is used as the surface potential meter.

The erasing device 37 irradiates the surface of the photoreceptor 31, which is charged by the charging device 34, with light to erase the charge remaining on the surface of the photoreceptor 31. As a light source of the erasing device 37, a halogen lamp is used and the surface of the photoreceptor 31 is illuminated with light emitted from the light source through a red filter through which only light having a wavelength of 600 nm or higher passes.

The current measuring device 43 measures a current flowing through the photoreceptor 31 during charging and is connected to the photoreceptor 31 and a ground. As the current measuring device 43, an ammeter Model 614 (manufactured by Keithley Instruments Inc.) is used.

The exposure device 26 exposes the surface of the photoreceptor 31, which is charged by the charging device 34, to light. The exposure device 26 includes a halogen lamp as a light source; a wavelength adjusting device that adjusts a wavelength of light which is emitted from the halogen lamp to the photoreceptor 31; an exposure adjusting device that adjusts an intensity of light in an optical path, ranging from the halogen lamp as the exposure light source to the photoreceptor 31; a slit that limits an illumination range of light; a half mirror that splits a part of the light emitted from the halogen lamp to the photoreceptor 31; and a lens that collects light, emitted from the halogen lamp, to the photoreceptor. In addition, the exposure device 26 also includes an optical power meter which measures an optical power of light split by the half mirror and thus has a configuration of calculating an optical power of light, emitted to the surface of the photoreceptor 31, from the optical power split by the half mirror by using the relationship between an optical power of an exposed surface of the photoreceptor 31, which is obtained in advance, and the optical power split by the half mirror. The wavelength adjusting device includes a filter for adjusting a wavelength of 780 nm and illuminates the surface of the photoreceptor with light having a wavelength of 780 nm.

The potential measuring device 35 and the erasing device 37 are arranged such that, when the position of the charging device 34 is set as reference (0°) and the downstream side in the rotating direction of the photoreceptor 31 is set as a “+” angle side, the exposure device 26 has an angle of 90°, the potential measuring device 35 has an angle of 120°, and the erasing device 37 has an angle of 270°.

Using the measuring apparatus 400 having the above-described configuration, the surface potential of the photoreceptor 31 is measured.

First, the temperature and the humidity in the measuring apparatus 400 are set to 20° C. and 40%, respectively; the photoreceptor 31 is attached to the support portions 38 and 39 of the measuring apparatus 400; the photoreceptor 31 is moved by the automatic stage 42; and a position of the photoreceptor 31 122 mm distant from an end thereof (the central position of the photoreceptor 31 in the axial direction) is aligned relative to the positions of the charging device 34, the exposure device 26, the potential measuring device 35, and the erasing device 37. The light intensity of the erasing device 37 is set to 175 mJ/m²; the current of a scorotron wire in the charging device 34 is set to 150 μA while the rotary motor 45 rotates the photoreceptor 31 at a rotational speed of 66.7 rpm; and the grid voltage of the scorotron is adjusted to have a surface potential of the photoreceptor of +800 V in a state where the exposure device does not emit light. Next, the exposure device emits light and an exposure in which the surface potential of the photoreceptor is +400 V is obtained as a half decay exposure during positive charging.

In addition, a half decay exposure during negative charging is measured with the same measurement method as that of the half decay exposure during positive charging, except that the charge amount of the photoreceptor is changed from “+800 V” to “−800 V” and the surface potential of the photoreceptor during light illumination is changed from “+400 V” to “−400 V”.

Values described in this specification are measured with the above-described methods.

### Achievement Method

Examples of a method of controlling the half decay exposure during positive charging to be in the above-described range include a method of adjusting the kinds and the amounts of the charge generation material, the hole transport material, and the electron transport material included in the single-layer photosensitive layer; and a method of adjusting the thickness of the single-layer photosensitive layer.

For example, as the content of the charge generation material increases, the half decay exposure during positive charging has a tendency to decrease; as the content of the electron transport material increases, the half decay exposure during positive charging has a tendency to decrease; and as the thickness of the single-layer photosensitive layer increases, the half decay exposure during positive charging has a tendency to decrease.

Examples of a method of controlling a ratio of the half decay exposure during negative charging to the half decay exposure during positive charging to be in the above-described range include a method of adjusting the half decay exposure during negative charging based on the half decay exposure during positive charging adjusted with the above-described method and the like. Examples of the method of adjusting the half decay exposure during negative charging include a method of adjusting the kinds and the amounts of the charge generation material, the hole transport material, and the electron transport material included in the single-layer photosensitive layer; and a method of adjusting the thickness of the single-layer photosensitive layer.

For example, as the content of the charge generation material increases, the half decay exposure during negative charging has a tendency to increase; as the content of the electron transport material increases, the half decay exposure during negative charging has a tendency to decrease; and as the thickness of the single-layer photosensitive layer increases, the half decay exposure during negative charging has a tendency to decrease.

The ratio of the half decay exposure during negative charging to the half decay exposure during positive charging is controlled by adjusting the balance between the kinds and the amounts of the above-described respective compositions.

From the viewpoints of controlling the half decay exposure during positive charging and the ratio of the half decay exposure during negative charging to the half decay exposure during positive charging to be in the above-described ranges, the content of the charge generation material in the single-layer photosensitive layer according to the exemplary embodiment is preferably from 3% by weight to 12% by weight, more preferably from 5% by weight to 10% by weight, and still more preferably from 6% by weight to 8% by weight, with respect to the content of the binder resin.

Next, a configuration of the electrophotographic photoreceptor according to the exemplary embodiment will be described with reference to the drawings.

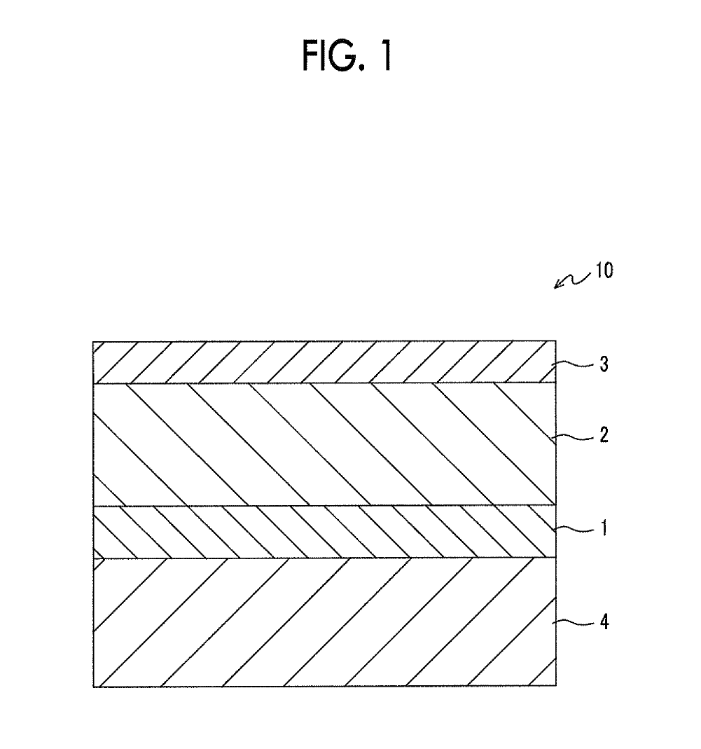

FIG. 1 is a cross-sectional view schematically illustrating a part of an electrophotographic photoreceptor 10 according to the exemplary embodiment.

The electrophotographic photoreceptor 10 illustrated in FIG. 1 includes, for example, a conductive support 4. On the conductive support 4, an undercoat layer 1, a single-layer photosensitive layer 2, and a protective layer 3 are provided in this order.

The undercoat layer 1 and the protective layer 3 are optionally provided.

Hereinafter, the respective components of the electrophotographic photoreceptor 10 will be described. Reference numerals will be omitted.

### Conductive Substrate

Any conductive substrates may be used as long as they are used in the related art. Examples thereof include plastic films provided with a thin film (for example, a film of a metal such as aluminum, nickel, chromium, or stainless steel, or a film of aluminum, titanium, nickel, chromium, stainless steel, gold, vanadium, tin oxide, indium oxide, or indium tin oxide (ITO)); various kinds of paper coated or impregnated with a conductivity-imparting agent; and plastic films coated or impregnated with a conductivity-imparting agent. The shape of the substrate is not limited to a cylindrical shape, and may be a sheet-like shape or a plate-like shape.

When a metal pipe is used as the conductive substrate, a surface thereof may be not subjected any treatments or may be subjected in advance to mirror-surface cutting, etching, anodic oxidation, rough machining, centerless grinding, sand blasting, wet honing, or the like.

### Undercoat Layer

The undercoat layer is optionally provided in order to prevent light from being reflected from the surface of the conductive substrate and prevent an unnecessary carrier from being infiltrated from the conductive substrate into the photosensitive layer.

For example, the undercoat layer includes a binder resin and optionally other additives.

Examples of the binder resin included in the undercoat layer include well-known polymer resin compounds such as acetal resins (for example, polyvinyl butyral), polyvinyl alcohol resins, caseins, polyamide resins, cellulosic resins, gelatins, polyurethane resins, polyester resins, methacrylic resins, acrylic resins, polyvinylchloride resins, polyvinyl acetate resins, vinyl chloride-vinyl acetate-maleic anhydride resins, silicone resins, silicone-alkyd resins, phenol resins, phenol-formaldehyde resins, melamine resins, urethane resins; and conductive resins such as charge transport resins or polyanilines having a charge transport group. Among these, resins which are insoluble in a coating solvent of an upper layer are preferably used. In particular, for example, phenol resins, phenol-formaldehyde resins, melamine resins, urethane resins, and epoxy resins are preferably used.

The undercoat layer may contain a metal compound such as a silicon compound, an organic zirconium compound, an organic titanium compound, or an organic aluminum compound.

The mixing ratio of the metal compound and the binder resin is not particularly limited and is set in a range where desired electrophotographic photoreceptor characteristics are obtained.

In order to adjust the surface roughness, resin particles may be added to the undercoat layer. Examples of the resin particles include silicone resin particles and cross-linked polymethylmethacrylate (PMMA) resin particles. In order to adjust the surface roughness, a surface of the undercoat layer may be polished after being formed. Examples of the polishing method include buffing, sand blasting, wet honing, and grinding.

The undercoat layer includes, for example, at least the binder resin and conductive particles. It is preferable that the conductive particles be conductive to have, for example, a volume resistivity of less than 10⁷ Ω·cm.

Examples of the conductive particles include metal particles (for example, particles of aluminum, copper, nickel, silver, or the like), conductive metal oxide particles (for example, particles of antimony oxide, indium oxide, tin oxide, zinc oxide, or the like), and particles of conductive materials (particles of carbon fiber, carbon black, or graphite). Among these, conductive metal oxide particles are preferable. As the conductive particles, the above examples may be used as a mixture of two or more kinds.

In addition, surfaces of the conductive particles may be treated with a hydrophobing agent (for example, a coupling agent) and the resistance thereof may be adjusted.

The content of the conductive particles is, for example, preferably from 10% by weight to 80% by weight and more preferably from 40% by weight to 80% by weight with respect to the binder resin.

When the undercoat layer is formed, an undercoat-layer-forming coating solution in which the above components are added to a solvent is used.

In addition, examples of a method of dispersing particles in the undercoat-layer-forming coating solution include media dispersers such as a ball mill, a vibration ball mill, an attritor, a sand mill, and a horizontal sand mill; and medialess dispersers such as a stirrer, an ultrasonic disperser, a roll mill, and a high-pressure homogenizer. Examples of the high-pressure homogenizer include a collision type of dispersing a dispersion through liquid-liquid collision or liquid-wall collision in a high-pressure state; and a pass-through type of dispersing a dispersion by causing it to pass through a fine flow path in a high-pressure state.

Examples of a method of coating the undercoat-layer-forming coating solution on the conductive substrate include a dip coating method, a push-up coating method, a wire-bar coating method, a spray coating method, a blade coating method, a knife coating method, and a curtain coating method.

The thickness of the undercoat layer is preferably greater than or equal to 15 μm and more preferably from 20 to 50 μm.

Although not illustrated in the drawing, an interlayer may be provided between the undercoat layer and the photosensitive layer. Examples of a binder resin used for the interlayer include polymer resin compounds such as acetal resins such as polyvinyl butyral, polyvinyl alcohol resins, caseins, polyamide resins, cellulosic resins, gelatins, polyurethane resins, polyester resins, methacrylic resins, acrylic resins, polyvinylchloride resins, polyvinyl acetate resins, vinyl chloride-vinyl acetate-maleic anhydride resins, silicone resins, silicone-alkyd resins, phenol-formaldehyde resins, and melamine resins; and organic metal compounds containing zirconium, titanium, aluminum, manganese, or silicon. These compounds may be used alone or as a mixture or a polycondensate of plural kinds of compounds. Among these, organic metal compounds containing zirconium or silicon are preferable from the viewpoints of low residual potential, less change in potential due to an environment, and less change in potential due to repetitive use.

When the interlayer is formed, an interlayer-forming coating solution in which the above components are added to a solvent is used.

Examples of a coating method used for forming the interlayer include well-known methods such as a dip coating method, a push-up coating method, a wire-bar coating method, a spray coating method, a blade coating method, a knife coating method, and a curtain coating method.

The interlayer has a function of improving a coating property of an upper layer as well as a function of an electrical blocking layer. Therefore, when the thickness thereof is too large, electrical blocking works excessively, which may lead to a decrease in sensitivity and an increase in potential due to repetitive use. Therefore, when the interlayer is formed, the thickness thereof is preferably set to be from 0.1 μm to 3 μm. In addition, in this case, the interlayer may be used as the undercoat layer.

### Single-Layer Photosensitive Layer

The single-layer photosensitive layer includes a binder resin, a charge generation material, a hole transport material, an electron transport material, and optionally other additives.

### Binder Resin

The binder resin is not particularly limited, and examples thereof include polycarbonate resins, polyester resins, polyarylate resins, methacrylic resins, acrylic resins, polyvinylchloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone-alkyd resins, phenol-formaldehyde resins, styrene-alkyd resins, poly-N-vinylcarbazoles, and polysilanes. As the binder resin, the above examples may be used alone or as a mixture of two or more kinds.

In particular, among these examples, polycarbonate resins having, for example, a viscosity average molecular weight of from 50,000 to 80,000 is preferable from the viewpoint of a film-forming property of the photosensitive layer.

### Charge Generation Material

As the charge generation material, well-known charge generation materials of the related art are used, and examples thereof include hydroxygallium phthalocyanine pigments, chlorogallium phthalocyanine pigments, titanyl phthalocyanine pigments, metal-free phthalocyanine pigments, and silicon phthalocyanine pigments.

Among these, at least one kind selected from hydroxygallium phthalocyanine pigments and chlorogallium phthalocyanine pigments is preferably used.

As the charge generation material, these pigments may be used alone or in a combination of two or more kinds as necessary. As the charge generation material, a V-type hydroxygallium phthalocyanine pigments are preferable from the viewpoint of increasing sensitivity of the photoreceptor during positive charging.

The hydroxygallium phthalocyanine pigments are not particularly limited, but a V-type hydroxygallium phthalocyanine pigment is preferable.

In particular, a hydroxygallium phthalocyanine pigment having a maximum peak wavelength of from 810 nm to 839 nm in a spectral absorption spectrum of a wavelength range of from 600 nm to 900 nm are preferable. This hydroxygallium phthalocyanine pigment is different from a V-type hydroxygallium phthalocyanine pigment of the related art and is preferable from the viewpoint of obtaining superior dispersibility. In this way, the maximum peak wavelength in the spectral absorption spectrum is shorter than that of a V-type hydroxygallium phthalocyanine pigment of the related art. As a result, a fine hydroxygallium phthalocyanine pigment in which the crystal orientation of pigment particles is preferably controlled is obtained. When this hydroxygallium phthalocyanine pigment is used as a material of the electrophotographic photoreceptor, superior dispersibility, sufficient sensitivity, charging property, and dark decay characteristics are easily obtained.

In addition, in the hydroxygallium phthalocyanine pigment having a maximum peak wavelength of from 810 nm to 839 nm, it is preferable that the average particle diameter be in a specific range and the BET specific surface area be in a specific range. Specifically, the average particle diameter is preferably less than or equal to 0.20 μm and more preferably from 0.01 μm to 0.15 μm, and the BET specific surface area is preferably greater than or equal to 45 m²/g, more preferably greater than or equal to 50 m²/g, and still more preferably from 55 m²/g to 120 m²/g. The average particle diameter is a value measured as a volume average particle diameter (d50 average particle diameter) with a laser diffraction/scattering particle size distribution analyzer (LA-700, manufactured by Horiba Ltd.). In addition, the BET specific surface area is a value measured using a BET specific surface area analyzer (manufactured by Shimadzu Corporation, FLOWSORB II 2300) with a nitrogen substitution method.

When the average particle diameter is greater than 0.20 μm or when the specific surface area is less than 45 m²/g, pigment particles have a tendency to coarse or to form aggregates of the pigment particles. As a result, problems with characteristics such as dispersibility, sensitivity, a charging property, or dark decay characteristics are likely to occur and thus image defects are likely to occur.

The maximum particle diameter (maximum value of primary particle diameter) of the hydroxygallium phthalocyanine pigment is preferably less than or equal to 1.2 μm, more preferably less than or equal to 1.0 μm, and still more preferably less than or equal to 0.3 μm. When the maximum particle diameter is beyond the above range, dark spots are likely to occur.

In the hydroxygallium phthalocyanine pigment, it is preferable that the average particle diameter be less than or equal to 0.2 μm, the maximum particle diameter be less than or equal to 1.2 μm, and the specific surface area be greater than or equal to 45 m²/g, from the viewpoint of suppressing unevenness in density caused by the photoreceptor being exposed to fluorescent light or the like.

It is preferable that the hydroxygallium phthalocyanine pigment be a V-type having diffraction peaks at Bragg angles (2θ±0.2°) of 7.3°, 16.0°, 24.9°, and 28.0° in an X-ray diffraction spectrum using CuKα characteristic X-rays.

The chlorogallium phthalocyanine pigment is not particularly limited, and examples thereof include a chlorogallium phthalocyanine pigment having diffraction peaks at Bragg angles (2θ±0.2°) of 7.4°, 16.6°, 25.5°, and 28.3° in which superior sensitivity is obtained as an electrophotographic photoreceptor material.

Of the chlorogallium phthalocyanine pigment, the maximum peak wavelength in a spectral absorption spectrum, the average particle diameter, the maximum particle diameter, and the specific surface area which are preferable are the same as those of the hydroxygallium phthalocyanine pigment.

As described above, the content of the charge generation material is from 3% by weight to 12% by weight with respect to the content of the binder resin.

### Hole Transport Material

As the hole transport material, well-known hole transport materials of the related art are used. Among those, a hole transport material represented by Formula (1) is preferably used.

However, the hole transport material which may be used in the exemplary embodiment is not limited to the hole transport material represented by Formula (1), and other hole transport materials may be used. Other hole transport materials will be described later.

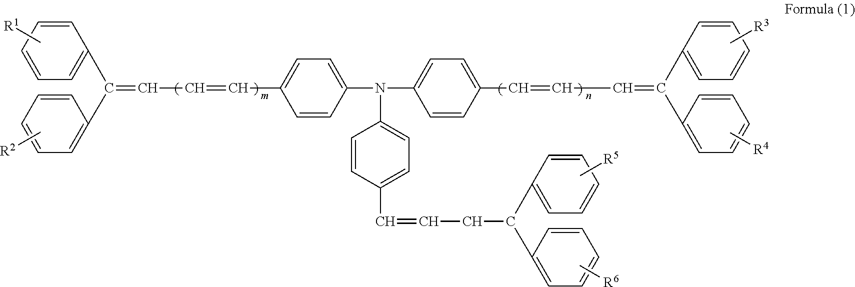

In Formula (1), R¹, R², R³, R⁴, R⁵, and R⁶ each independently represent a hydrogen atom, a lower alkyl group, an alkoxy group, a phenoxy group, a halogen atom, or a phenyl group which may have a substituent selected from a lower alkyl group, an alkoxy group, and a halogen atom; and m and n each independently represent 0 or 1.

In Formula (1), the lower alkyl group represented by R¹ to R⁶ represents, for example, a linear or branched alkyl group having from 1 to 4 carbon atoms, and specific examples thereof include a methyl group, an ethyl group, an n-propyl group, an isopropyl group, an n-butyl group, and an isobutyl group.

Among these, as the lower alkyl group, a methyl group and an ethyl group are preferable.

In Formula (1), the alkoxy group represented by R¹ to R⁶ represents, for example, an alkoxy group having from 1 to 4 carbon atoms, and specific examples thereof include a methoxy group, an ethoxy group, a propoxy group, and a butoxy group.

In Formula (1), examples of the halogen atom represented by R¹ to R⁶ include a fluorine atom, a chlorine atom, a bromine atom, or an iodine atom.

In Formula (1), the phenyl group represented by R¹ to R⁶ include, for example, an unsubstituted phenyl group; a phenyl group substituted with a lower alkyl group such as a p-tolyl group or a 2,4-dimethylphenyl group; a phenyl group substituted with a lower alkoxy group such as p-methoxyphenyl group; and a phenyl group substituted with a halogen atom such as p-chlorophenyl group.

Examples of the substituent which may be substituted with a phenyl group include a lower alkyl group, an alkoxy group, and a halogen atom which are represented by R¹ to R⁶.

As the hole transport material represented by Formula (1), from the viewpoints of increasing sensitivity and suppressing point defects of an image, a hole transport material in which m and n represent 1 is preferable and a hole transport material in which R¹ to R⁶ each independently represent a hydrogen atom, a lower alkyl group, or an alkoxy group; and m and n represent 1 is particularly preferable.

Hereinafter, exemplary compounds of the hole transport material represented by Formula (1) are shown below, but the hole transport material represented by Formula (1) is not limited thereto.

| Exemplary | | | | | | | | |
|---|---|---|---|---|---|---|---|---|
| Compound | m | n | R¹ | R² | R³ | R⁴ | R⁵ | R⁶ |
| 1 | 1 | 1 | H | H | H | H | H | H |
| 2 | 1 | 1 | 4-Me | 4-Me | 4-Me | 4-Me | 4-Me | 4-Me |
| 3 | 1 | 1 | 4-Me | 4-Me | H | H | 4-Me | 4-Me |
| 4 | 1 | 1 | 4-Me | H | 4-Me | H | 4-Me | H |
| 5 | 1 | 1 | H | H | 4-Me | 4-Me | H | H |
| 6 | 1 | 1 | 3-Me | 3-Me | 3-Me | 3-Me | 3-Me | 3-Me |
| 7 | 1 | 1 | H | H | H | H | 4-Cl | 4-Cl |
| 8 | 1 | 1 | 4-OMe | H | 4-OMe | H | 4-OMe | H |
| 9 | 1 | 1 | H | H | H | H | 4-OMe | 4-OMe |
| 10 | 1 | 1 | 4-OMe | 4-OMe | 4-OMe | 4-OMe | 4-OMe | 4-OMe |
| 11 | 1 | 1 | 4-OMe | H | 4-OMe | H | 4-OMe | 4-OMe |
| 12 | 1 | 1 | 4-Me | H | 4-Me | H | 4-Me | 4-F |
| 13 | 1 | 1 | 3-Me | H | 3-Me | H | 3-Me | H |
| 14 | 1 | 1 | 4-Cl | H | 4-Cl | H | 4-Cl | H |
| 15 | 1 | 1 | 4-Cl | 4-Cl | 4-Cl | 4-Cl | 4-Cl | 4-Cl |
| 16 | 1 | 1 | 3-Me | 3-Me | 3-Me | 3-Me | 3-Me | 3-Me |
| 17 | 1 | 1 | 4-Me | 4-OMe | 4-Me | 4-OMe | 4-Me | 4-OMe |
| 18 | 1 | 1 | 3-Me | 4-OMe | 3-Me | 4-OMe | 3-Me | 4-OMe |
| 19 | 1 | 1 | 3-Me | 4-Cl | 3-Me | 4-Cl | 3-Me | 4-Cl |
| 20 | 1 | 1 | 4-Me | 4-Cl | 4-Me | 4-Cl | 4-Me | 4-Cl |
| 21 | 1 | 0 | H | H | H | H | H | H |
| 22 | 1 | 0 | 4-Me | 4-Me | 4-Me | 4-Me | 4-Me | 4-Me |
| 23 | 1 | 0 | 4-Me | 4-Me | H | H | 4-Me | 4-Me |
| 24 | 1 | 0 | H | H | 4-Me | 4-Me | H | H |
| 25 | 1 | 0 | H | H | 3-Me | 3-Me | H | H |
| 26 | 1 | 0 | H | H | 4-Cl | 4-Cl | H | H |
| 27 | 1 | 0 | 4-Me | H | H | H | 4-Me | H |
| 28 | 1 | 0 | 4-OMe | H | H | H | 4-OMe | H |
| 29 | 1 | 0 | H | H | 4-OMe | 4-OMe | H | H |
| 30 | 1 | 0 | 4-OMe | 4-OMe | 4-OMe | 4-OMe | 4-OMe | 4-OMe |
| 31 | 1 | 0 | 4-OMe | H | 4-OMe | H | 4-OMe | 4-OMe |
| 32 | 1 | 0 | 4-Me | H | 4-Me | H | 4-Me | 4-F |
| 33 | 1 | 0 | 3-Me | H | 3-Me | H | 3-Me | H |
| 34 | 1 | 0 | 4-Cl | H | 4-Cl | H | 4-Cl | H |
| 35 | 1 | 0 | 4-Cl | 4-Cl | 4-Cl | 4-Cl | 4-Cl | 4-Cl |
| 36 | 1 | 0 | 3-Me | 3-Me | 3-Me | 3-Me | 3-Me | 3-Me |
| 37 | 1 | 0 | 4-Me | 4-OMe | 4-Me | 4-OMe | 4-Me | 4-OMe |
| 38 | 1 | 0 | 3-Me | 4-OMe | 3-Me | 4-OMe | 3-Me | 4-OMe |
| 39 | 1 | 0 | 3-Me | 4-Cl | 3-Me | 4-Cl | 3-Me | 4-Cl |
| 40 | 1 | 0 | 4-Me | 4-Cl | 4-Me | 4-Cl | 4-Me | 4-Cl |
| 41 | 0 | 0 | H | H | H | H | H | H |
| 42 | 0 | 0 | 4-Me | 4-Me | 4-Me | 4-Me | 4-Me | 4-Me |
| 43 | 0 | 0 | 4-Me | 4-Me | 4-Me | 4-Me | H | H |
| 44 | 0 | 0 | 4-Me | H | 4-Me | H | H | H |
| 45 | 0 | 0 | H | H | H | H | 4-Me | 4-Me |
| 46 | 0 | 0 | 3-Me | 3-Me | 3-Me | 3-Me | H | H |
| 47 | 0 | 0 | H | H | H | H | 4-Cl | 4-Cl |
| 48 | 0 | 0 | 4-OMe | H | 4-OMe | H | H | H |
| 49 | 0 | 0 | H | H | H | H | 4-OMe | 4-OMe |
| 50 | 0 | 0 | 4-OMe | 4-OMe | 4-OMe | 4-OMe | 4-OMe | 4-OMe |
| 51 | 0 | 0 | 4-OMe | H | 4-OMe | H | 4-OMe | 4-OMe |
| 52 | 0 | 0 | 4-Me | H | 4-Me | H | 4-Me | 4-F |
| 53 | 0 | 0 | 3-Me | H | 3-Me | H | 3-Me | H |
| 54 | 0 | 0 | 4-Cl | H | 4-Cl | H | 4-Cl | H |
| 55 | 0 | 0 | 4-Cl | 4-Cl | 4-Cl | 4-Cl | 4-Cl | 4-Cl |
| 56 | 0 | 0 | 3-Me | 3-Me | 3-Me | 3-Me | 3-Me | 3-Me |
| 57 | 0 | 0 | 4-Me | 4-OMe | 4-Me | 4-OMe | 4-Me | 4-OMe |
| 58 | 0 | 0 | 3-Me | 4-OMe | 3-Me | 4-OMe | 3-Me | 4-OMe |
| 59 | 0 | 0 | 3-Me | 4-Cl | 3-Me | 4-Cl | 3-Me | 4-Cl |
| 60 | 0 | 0 | 4-Me | 4-Cl | 4-Me | 4-Cl | 4-Me | 4-Cl |
| 61 | 1 | 1 | 4-Pr | 4-Pr | 4-Pr | 4-Pr | 4-Pr | 4-Pr |
| 62 | 1 | 1 | 4-OPh | 4-OPh | 4-OPh | 4-OPh | 4-OPh | 4-OPh |
| 63 | 1 | 1 | H | 4-Me | H | 4-Me | H | 4-Me |
| 64 | 1 | 1 | 4-C₆H₅ | 4-C₆H₅ | 4-C₆H₅ | 4-C₆H₅ | 4-C₆H₅ | 4-C₆H₅ |

The abbreviations of the exemplary compounds shown above represent as follows.

4-Me: Methyl group substituted at 4-position of phenyl group

3-Me: Methyl group substituted at 3-position of phenyl group

4-Cl: Chlorine atom substituted at 4-position of phenyl group

4-OMe: Methoxy group substituted at 4-position of phenyl group

4-F: Fluorine atom substituted at 4-position of phenyl group

4-Pr: Propyl group substituted at 4-position of phenyl group

4-OPh: Phenoxy group substituted at 4-position of phenyl group

The content of the hole transport material is, for example, preferably from 10% by weight to 98% by weight, more preferably from 60% by weight to 95% by weight, and still more preferably from 70% by weight to 90% by weight, with respect to the binder resin.

### Electron Transport Material

As the electron transport material, well-known electron transport materials of the related art are used. Among those, an electron transport material represented by Formula (2) is preferably used.

However, the electron transport material which may be used in the exemplary embodiment is not limited to the electron transport material represented by Formula (2), and other electron transport materials may be used. Other electron transport materials will be described later.

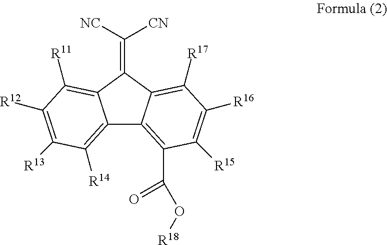

In Formula (2), R¹¹, R¹², R¹³, R¹⁴, R¹⁵, R¹⁶, and R¹⁷ each independently represent a hydrogen atom, a halogen atom, an alkyl group, an alkoxy group, or an aryl group; and R¹⁸ represents an alkyl group.

In Formula (2), examples of the halogen atom represented by R¹¹ to R¹⁷ include a fluorine atom, a chlorine atom, a bromine atom, or an iodine atom.

In Formula (2), the alkyl group represented by R¹¹ to R¹⁷ represents, for example, a linear or branched alkyl group having from 1 to 4 carbon atoms (preferably having from 1 to 3 carbon atoms), and specific examples thereof include a methyl group, an ethyl group, an n-propyl group, an isopropyl group, an n-butyl group, and an isobutyl group.

In Formula (2), the alkoxy group represented by R¹¹ to R¹⁷ represents, for example, an alkoxy group having from 1 to 4 carbon atoms (preferably having from 1 to 3 carbon atoms), and specific examples thereof include a methoxy group, an ethoxy group, a propoxy group, and a butoxy group.

In Formula (2), examples of the aryl group represented by R¹¹ to R¹⁷ include a phenyl group, a benzyl group, and a tolyl group.

Among these, a phenyl group is preferable.

As the electron transport material represented by Formula (2), from the viewpoints of increasing sensitivity and suppressing point defects of an image, an electron transport material, in which R¹¹ to R¹⁷ each independently represent a hydrogen atom, a halogen atom, or an alkyl group; and R¹⁸ represents a linear alkyl group having from 5 to 10 carbon atoms, is particularly preferable.

Hereinafter, exemplary compounds of the electron transport material represented by Formula (2) are shown below, but the electron transport material represented by Formula (2) is not limited thereto.

| Exemplary | | | | | | | | |
|---|---|---|---|---|---|---|---|---|
| Compound | R¹¹ | R¹² | R¹³ | R¹⁴ | R¹⁵ | R¹⁶ | R¹⁷ | R¹⁸ |
| 1 | H | H | H | H | H | H | H | -n-C₇H₁₅ |
| 2 | H | H | H | H | H | H | H | -n-C₈H₁₇ |
| 3 | H | H | H | H | H | H | H | -n-C₅H₁₁ |
| 4 | H | H | H | H | H | H | H | -n-C₁₀H₂₁ |
| 5 | Cl | Cl | Cl | Cl | Cl | Cl | Cl | -n-C₇H₁₅ |
| 6 | H | Cl | H | Cl | H | Cl | Cl | -n-C₇H₁₅ |
| 7 | CH₃ | CH₃ | CH₃ | CH₃ | CH₃ | CH₃ | CH₃ | -n-C₇H₁₅ |
| 8 | C₄H₉ | C₄H₉ | C₄H₉ | C₄H₉ | C₄H₉ | C₄H₉ | C₄H₉ | -n-C₇H₁₅ |
| 9 | CH₃O | H | CH₃O | H | CH₃O | H | CH₃O | -n-C₈H₁₇ |
| 10 | C₆H₅ | C₆H₅ | C₆H₅ | C₆H₅ | C₆H₅ | C₆H₅ | C₆H₅ | -n-C₈H₁₇ |

The content of the electron transport material is, for example, preferably from 10% by weight to 70% by weight, more preferably from 15% by weight to 60% by weight, and still more preferably from 20% by weight to 50% by weight, with respect to the binder resin.

### Other Charge Transport Material

As described above, as the hole transport material and the electron transport material, other charge transport materials (other hole transport materials and other electron transport materials) may be used, in addition to the hole transport material represented by Formula (1) and the electron transport material represented by Formula (2).

Examples of other charge transport materials include electron transport compounds such as quinone compounds (for example, p-benzoquinone, chloranil, bromanil, and anthraquinone), tetracyanoquinodimethane compounds, fluorenone compounds (for example, 2,4,7-trinitrofluorenone), xanthone compounds, benzophenone compounds, cyanovinyl compounds, and ethylene compounds; and hole transport compounds such as triarylamine compounds, benzidine compounds, arylalkane compounds, aryl-substituted ethylene compounds, stilbene compounds, anthracene compounds, and hydrazone compounds. As other charge transport materials, the above examples may be used alone or as a mixture of two or more kinds thereof, but other charge transport materials are not limited thereto.

As other charge transport materials, from the viewpoint of charge mobility, triarylamine derivatives represented by Formula (B-1) and benzidine derivatives represented by Formula (B-2) are preferable.

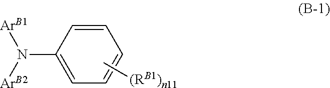

In Formula (B-1), R^{B1} represents a hydrogen atom or a methyl group; n11 represents 1 or 2; Ar^{B1} and Ar^{B2} each independently represent a substituted or unsubstituted aryl group, —C₆H₄—C(R^{B3})═C(R^{B4})(R^{B5}), or —C₆H₄—CH═CH—CH═C(R^{B6})(R^{B7}); and R^{B3} to R^{B7} each independently represent a hydrogen atom, a substituted or unsubstituted alkyl group, or a substituted or unsubstituted aryl group. Examples of a substituent include a halogen atom, an alkyl group having from 1 to 5 carbon atoms, an alkoxy group having from 1 to 5 carbon atoms, or an amino group substituted with an alkyl group having from 1 to 3 carbon atoms.

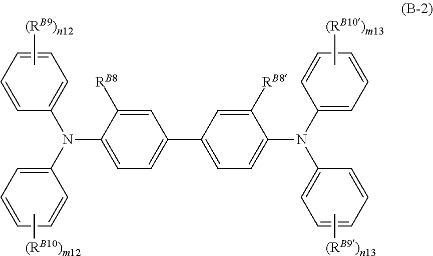

In Formula (B-2), R^{B8} and R^{B8′} be the same as or different from each other and each independently represent a hydrogen atom, a halogen atom, an alkyl group having from 1 to 5 carbon atoms, or an alkoxy group having from 1 to 5 carbon atoms; R^{B9}, R^{B9′}, R^{B10}, and R^{B10′} may be the same as or different from each other and each independently represent a halogen atom, an alkyl group having from 1 to 5 carbon atoms, an alkoxy group having from 1 to 5 carbon atoms, an amino group substituted with an alkyl group having 1 or 2 carbon atoms, a substituted or unsubstituted aryl group, —C(R^{B11})═C(R^{B12})(R^{B13}), or —CH═CH—CH═C(R^{B14})(R^{B15}); R^{B11} to R^{B15} each independently represent a hydrogen atom, a substituted or unsubstituted alkyl group, or a substituted or unsubstituted aryl group; and m12, m13, n12, and n13 each independently represent an integer of from 0 to 2.

Among the triarylamine derivatives represented by Formula (B-1) and the benzidine derivatives represented by Formula (B-2), a triarylamine derivative having “—C₆H₄—CH═CH—CH═C(R^{B6})(R^{B7})” and a benzidine derivative having “—CH═CH—CH═C(R^{B14})(R^{B15})” are particularly preferable.

### Ratio of Hole Transport Material to Electron Transport Material

The ratio of the hole transport material to the electron transport material (hole transport material/electron transport material) is preferably from 50/50 to 90/10 and more preferably from 60/40 to 80/20 in terms of weight.

When the hole transport material and the electron transport material are used in a combination of two or more kinds, this ratio represents a ratio of the total amounts thereof.

### Other Additives

The single-layer photosensitive layer may contain well-known additives such as an antioxidant, a light stabilizer, and a heat stabilizer. In addition, when the single-layer photosensitive layer is a surface layer, fluororesin particles, silicone oil, and the like may be included therein.

### Formation of Single-Layer Photosensitive Layer

The single-layer photosensitive layer is formed using a photosensitive-layer-forming coating solution in which the above components are added to a solvent.

Examples of the solvent include well-known organic solvents including aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. As the solvent, the above examples may be used alone or as a mixture of two or more kinds.

Examples of a method of dispersing particles (for example, particles of a charge generation material) in the photosensitive-layer-forming coating solution include media dispersers such as a ball mill, a vibration ball mill, an attritor, a sand mill, and a horizontal sand mill; and medialess dispersers such as a stirrer, an ultrasonic disperser, a roll mill, and a high-pressure homogenizer. Examples of the high-pressure homogenizer include a collision type of dispersing a dispersion through liquid-liquid collision or liquid-wall collision in a high-pressure state; and a pass-through type of dispersing a dispersion by causing it to pass through a fine flow path in a high-pressure state.

Examples of a method of coating the photosensitive-layer-forming coating solution on the conductive substrate or the undercoat layer include a dip coating method, a push-up coating method, a wire-bar coating method, a spray coating method, a blade coating method, a knife coating method, and a curtain coating method.

The thickness of the single-layer photosensitive layer is preferably from 5 μm to 60 μm and more preferably from 10 μm to 50 μm.

### Protective Layer

The protective layer is optionally provided in order to improve mechanical strength of the photosensitive layer and resistance to wear, damages, and the like on the surface of the electrophotographic photoreceptor.

Examples of the protective layer include well-known protective layers such as a polymer film (cross-linked film) of reactive charge transport materials, a resin cured film containing charge transport materials in a curable resin, and a film formed by adding a conductive material to a binder resin. As the protective film, a film using charge transport materials is preferable.

The thickness of the protective layer is, for example, preferably from 3 μm to 40 μm, more preferably from 5 μm to 35 μm, and still more preferably from 5 μm to 15 μm.

### Image Forming Apparatus and Process Cartridge

A process cartridge according to an exemplary embodiment of the invention is detachable from an image forming apparatus, and includes the electrophotographic photoreceptor according to the exemplary embodiment.

An image forming apparatus according to an exemplary embodiment of the invention includes the electrophotographic photoreceptor according to the exemplary embodiment; a charging unit that charges the electrophotographic photoreceptor; an electrostatic latent image forming unit that forms an electrostatic latent image on a charged electrophotographic photoreceptor; a developing unit that accommodates a developer containing a toner and develops the electrostatic latent image, formed on the electrophotographic photoreceptor, using the developer to form a toner image; and a transfer unit that transfers the toner image onto a transfer medium.

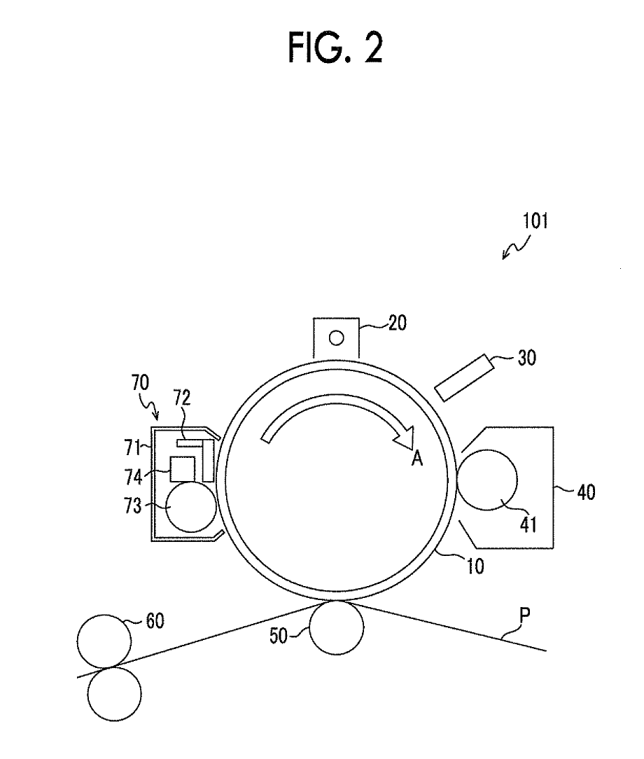

FIG. 2 is a diagram schematically illustrating a configuration of an image forming apparatus according to an exemplary embodiment of the invention.

As illustrated in FIG. 2, an image forming apparatus 101 according to the exemplary embodiment includes an electrophotographic photoreceptor 10 that rotates clockwise, for example, as indicated by arrow A; a charging device 20 (an example of a charging unit) that is provided facing to the electrophotographic photoreceptor 10 above the electrophotographic photoreceptor 10 and charges the surface of the electrophotographic photoreceptor 10; an exposure device 30 (an example of an electrostatic latent image forming unit) that exposes the surface of the electrophotographic photoreceptor 10, which is charged by the charging device 20, to light to form an electrostatic latent image; a developing device 40 (an example of a developing unit) that attaches a toner, which is included in a developer, to the electrostatic latent image, which is formed by the exposure device 30, to form a toner image on the surface of the electrophotographic photoreceptor 10; a transfer device 50 that charges a recording paper P (an example of transfer medium) to have a polarity different from a charge polarity of the toner such that the toner image on the electrophotographic photoreceptor 10 is transferred onto the recording paper P; and a cleaning device 70 (an example of a toner removal unit) that cleans the surface of the electrophotographic photoreceptor 10. In addition, a fixing device 60 that fixes the toner image while transporting the recording paper P on which the toner image is formed, is provided.

Hereinafter, main components of the image forming apparatus 101 according to the exemplary embodiment will be described in detail.

### Charging Device

Examples of the charging device 20 include contact charging devices using a charging roller, a charging brush, a charging film, a charging rubber blade, a charging tube, and the like which are conductive. In addition, examples of the charging device 20 include non-contact roller charging devices and well-known charging devices such as a scorotron charger or corotron charger using corona discharge.

When the contact charger is used as the charging unit, performance of erasing image history of a photoreceptor in the previous cycle is superior. Accordingly, when the non-contact charger is compared to the contact charger, ghosting occurs more easily.

### Exposure Device

Examples of the exposure device 30 include optical devices in which the surface of the electrophotographic photoreceptor 10 is exposed to light such as semiconductor laser light, LED light, and liquid crystal shutter light according to an image form. It is preferable that the wavelength of a light source fall within the spectral sensitivity range of the electrophotographic photoreceptor 10. It is preferable that the wavelength of a semiconductor laser light be in the near-infrared range having an oscillation wavelength of about 780 nm. However, the wavelength is not limited thereto. Laser light having an oscillation wavelength of about 600 nm or laser light having an oscillation wavelength of 400 nm to 450 nm as blue laser light may be used. In addition, in order to form a color image, as the exposure device 30, for example, a surface-emitting laser light source of emitting multiple beams is also effective.

### Developing Device

The developing device 40 has, for example, a configuration in which a developing roller 41, which is arranged in a development area opposite the electrophotographic photoreceptor 10, is provided in a container that accommodates a two-component developer including toner and a carrier. The developing device 40 is not particularly limited as long as it uses a two-component developer for development, and adopts a well-known configuration.

The developer used in the developing device 40 may be a single-component developer including toner or a two-component developer including toner and a carrier.

### Transfer Device

Examples of the transfer device 50 include contact transfer charging devices using a belt, a roller, a film, a rubber blade, and the like; and well-known transfer charging devices such as scorotron transfer charger or corotron transfer charger using corona discharge.

### Cleaning Device

The cleaning device 70 includes, for example, a case 71, a cleaning blade 72, a cleaning brush 73 which is disposed downstream of the cleaning blade 72 in a rotating direction of the electrophotographic photoreceptor 10. In addition, for example, the cleaning brush 73 is in contact with a solid lubricant 74.

Next, the operations of the image forming apparatus 101 according to the exemplary embodiment will be described. First, the electrophotographic photoreceptor 10 is charged to a negative potential by the charging device 20 while rotating along the direction indicated by arrow A.

The surface of the electrophotographic photoreceptor 10, which is charged to a negative potential by the charging device 20, is exposed to light by the exposure device 30 and an electrostatic latent image is formed thereon.

When a portion of the electrophotographic photoreceptor 10, where the electrostatic latent image is formed, approaches the developing device 40, toner is attached onto the electrostatic latent image by the developing device 40 (developing roller 41) and thus a toner image is formed.

When the electrophotographic photoreceptor 10 where the toner image is formed further rotates in the direction indicated by arrow A, the toner image is transferred onto the recording paper P by the transfer device 50. As a result, the toner image is formed on the recording paper P.

The toner image, which is formed on the recording paper P, is fixed on the recording paper P by the fixing device 60.

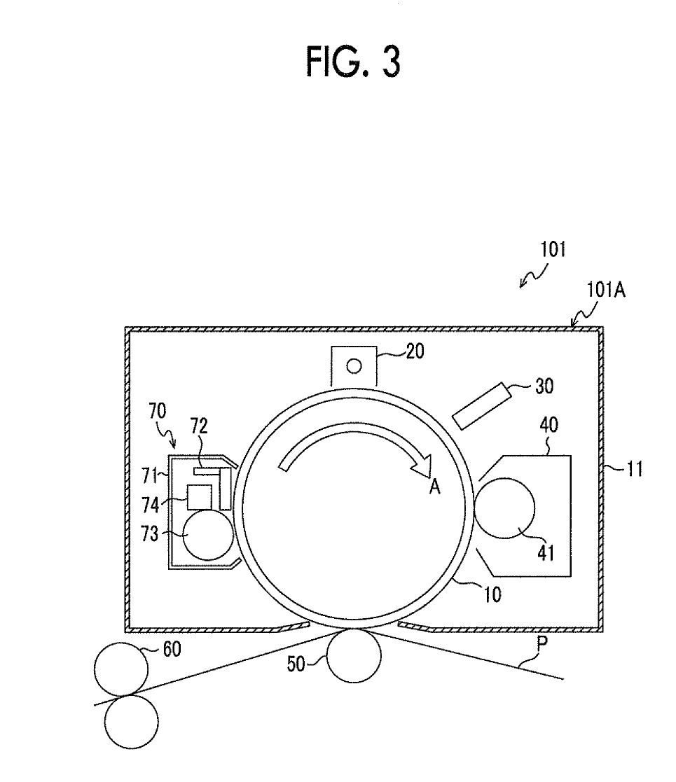

For example, as illustrated in FIG. 3, the image forming apparatus 101 according to the exemplary embodiment may include a process cartridge 101A which integrally accommodates the electrophotographic photoreceptor 10, the charging device 20, the exposure device 30, the developing device 40, and the cleaning device 70 in the case 11. This process cartridge 101A integrally accommodates the plural members and is detachable from the image forming apparatus 101.

The process cartridge 101A is not limited to the above configuration as long as it includes at least the electrophotographic photoreceptor 10, and may further include at least one selected from the charging device 20, the exposure device 30, the developing device 40, the transfer device 50, and the cleaning device 70.

In addition, the image forming apparatus 101 according to the exemplary embodiment is not limited to the above-described configurations. For example, a first erasing device for aligning the polarity of remaining toner and facilitating the cleaning brush to remove the remaining toner may be provided downstream of the transfer device 50 in the rotating direction of the electrophotographic photoreceptor 10 and upstream of the cleaning device 70 in the rotating direction of the electrophotographic photoreceptor 10 in the vicinity of the electrophotographic photoreceptor 10; or a second erasing device for erasing the charge on the surface of the electrophotographic photoreceptor 10 may be provided downstream of the cleaning device 70 in the rotating direction of the electrophotographic photoreceptor 10 and upstream of the charging device 20 in the rotating direction of the electrophotographic photoreceptor 10.

In a configuration not having the first erasing device or the second erasing device in a region which is located downstream of the transfer device 50 and is located upstream of the charging device 20 in the rotating direction of the electrophotographic photoreceptor, ghosting occurs more easily because image history of a photoreceptor in the previous cycle is not erased by the erasing unit.

In addition, the image forming apparatus 101 according to the exemplary embodiment is not limited to the above-described configurations and well-known configurations may be adopted. For example, an intermediate transfer type image forming apparatus, in which the toner image, which is formed on the electrophotographic photoreceptor 10, is transferred onto an intermediate transfer medium and then transferred onto the recording paper 2, may be adopted; or a tandem-type image forming apparatus may be adopted.

### EXAMPLES

Hereinafter, the present invention will be described in more detail with reference to Examples and Comparative Examples but is not limited thereto.

### Example 1

3 parts by weight of V-type hydroxygallium phthalocyanine pigment, as a charge generation material, having diffraction peaks at Bragg angles (2θ±0.2°) of at least 7.3°, 16.0°, 24.9°, and 28.0° in an X-ray diffraction spectrum using CuKα characteristic X-rays, 47 parts by weight of bisphenol Z polycarbonate resin (viscosity average molecular weight: 50,000) as a binder resin, 13 parts by weight of Electron transport material (1) shown in Table 1, 18 parts by weight of hole transport material represented by Compound 1 below, 19 parts by weight of hole transport material represented by Compound 2 below, and 250 parts by weight of tetrahydrofuran as a solvent are mixed to prepare a mixture. The mixture is dispersed for 4 hours using a sand mill with glass bead having a diameter of 1 mmφ. As a result, a photosensitive-layer-forming coating solution is obtained.

This photosensitive-layer-forming coating solution is dip-coated on an aluminum substrate having a diameter of 30 mm and a length of 245 mm, followed by drying and curing at 140° C. for 30 minutes. As a result, a single-layer photosensitive layer having a thickness of 30 μm is formed.

Through the above-described processes, an electrophotographic photoreceptor is prepared.

### Examples 2 to 9 and Comparative Examples 1 to 9

Electrophotographic photoreceptors are prepared with the same method of Example 1, except that the kinds and the amounts of the electron transport material, the hole transport material, the binder resin, and the charge generation material and the thickness of the single-layer photosensitive layer are changed according to Table 1. In Table 1, “part” represents “part by weight”.

### Evaluation

The electrophotographic photoreceptors obtained in the respective Examples are evaluated as follows. The results thereof are shown in Table 2.

### Measurement of Half Decay Exposures During Positive and Negative Charging

Using the above-described method, the half decay exposures during positive and negative charging in a photosensitive layer are measured and a ratio of the half decay exposure during negative charging to the half decay exposure during positive charging (ratio of Negative/Positive) is calculated.

### Evaluation for Ghosting

The evaluation for ghosting is performed with the following method. An ND filter having a transmittance of 50% is attached to an exposure optical path of a HL-5340D (manufactured by Brother Industries Ltd.). An electrophotographic photoreceptor is mounted to this modified machine and a ghost image is examined in an environment of 20° C. and 40%. As an image for the evaluation for ghosting, images having a 15 mm×15 mm square pattern are printed in arbitrary numbers corresponding to one revolution of the photoreceptor. Then, halftone images are printed on the entire surface in the next cycle and ghost images appearing on the half tone image are evaluated based on the following criteria.

A: Ghosting does not occur
Positive Ghosting: Positive ghosting occurs
Negative Ghosting: Negative ghosting occurs

### Evaluation for Density

The evaluation for the density of an image is performed with the following method. An ND filter having a transmittance of 50% is attached to an exposure optical path of a HL-5340D (manufactured by Brother Industries Ltd.). An electrophotographic photoreceptor is mounted to this modified machine, solid images are printed in an environment of 20° C. and 40%, and a density is measured for determination using a densitometer X-rite 04A (manufactured by X-Rite Inc).

A: Density is sufficient and there are no problems
C: Density deteriorates and there is a problem

| | | | | | | | | | | | | Ratio of | |
|---|---|---|---|---|---|---|---|---|---|---|---|---|---|
| | | Electron Transport | | | | | | | | Charge Generation | | [B]/[A] | Thick- |
| | | Material | | Hole Transport Material | | | | Binder Resin | | Material | | % By | ness |
| | | Kind | Part | Kind | Part | Kind | Part | Kind | Part [A] | Kind | Part [B] | Weight | μm |
| Example | 1 | (1) | 13 | Compound 1 | 18 | Compound 2 | 19 | PCZ | 47 | HOGaPC | 3 | 6.4 | 30 |
| | 2 | (1) | 20 | Compound 1 | 18 | Compound 2 | 19 | PCZ | 47 | HOGaPC | 3 | 6.4 | 30 |
| | 3 | (1) | 13 | Compound 1 | 18 | Compound 2 | 19 | PCZ | 47 | HOGaPC | 2 | 4.3 | 30 |
| | 4 | (1) | 13 | Compound 1 | 18 | Compound 2 | 19 | PCZ | 47 | HOGaPC | 1.5 | 3.2 | 30 |
| | 5 | (1) | 13 | Compound 1 | 18 | Compound 2 | 19 | PCZ | 47 | HOGaPC | 5 | 10.6 | 20 |
| | 6 | (1) | 13 | Compound 1 | 18 | Compound 2 | 19 | PCZ | 47 | HOGaPC | 5.5 | 11.7 | 15 |
| | 7 | (1) | 13 | Compound 1 | 18 | Compound 2 | 19 | PCZ | 47 | HOGaPC | 3 | 6.4 | 40 |
| | 8 | (2) | 13 | Compound 1 | 18 | Compound 2 | 19 | PCZ | 47 | HOGaPC | 3 | 6.4 | 30 |
| | 9 | (3) | 13 | Compound 1 | 18 | Compound 2 | 19 | PCZ | 47 | HOGaPC | 3 | 6.4 | 30 |
| | 10 | (4) | 13 | Compound 1 | 18 | Compound 2 | 19 | PCZ | 47 | HOGaPC | 3 | 6.4 | 30 |
| | 11 | (5) | 13 | Compound 1 | 18 | Compound 2 | 19 | PCZ | 47 | HOGaPC | 3 | 6.4 | 30 |
| | 12 | (6) | 13 | Compound 1 | 18 | Compound 2 | 19 | PCZ | 47 | HOGaPC | 3 | 6.4 | 30 |
| Comparative | 1 | (1) | 13 | Compound 1 | 18 | Compound 2 | 19 | PCZ | 47 | HOGaPC | 6 | 12.8 | 25 |
| Example | 2 | (1) | 13 | Compound 1 | 18 | Compound 2 | 19 | PCZ | 47 | HOGaPC | 1.2 | 2.6 | 30 |
| | 3 | (1) | 20 | Compound 1 | 18 | Compound 2 | 19 | PCZ | 47 | HOGaPC | 1.2 | 2.6 | 30 |
| | 4 | (1) | 10 | Compound 1 | 18 | Compound 2 | 19 | PCZ | 47 | HOGaPC | 1.5 | 3.2 | 30 |
| | 5 | (1) | 6 | Compound 1 | 18 | Compound 2 | 19 | PCZ | 47 | HOGaPC | 5 | 10.6 | 20 |
| | 6 | (1) | 13 | Compound 1 | 18 | Compound 2 | 19 | PCZ | 47 | H₂PC | 3 | 6.4 | 30 |
| | 7 | (1) | 13 | Compound 1 | 18 | Compound 2 | 19 | PCZ | 47 | ClGaPC | 3 | 6.4 | 30 |
| | 8 | (7) | 13 | Compound 1 | 18 | Compound 2 | 19 | PCZ | 47 | HOGaPC | 3 | 6.4 | 30 |
| | 9 | (7) | 13 | Compound 1 | 18 | Compound 2 | 19 | PCZ | 47 | H₂PC | 3 | 6.4 | 30 |

| | | Half Decay | Half Decay | | | |
|---|---|---|---|---|---|---|
| | | Exposure during | Exposure during | | | |
| | | Positive Charging | Negative Charging | Ratio of | | |
| | | [Positive] | [Negative] | [Negative]/ | | |
| | | μJ/cm² | μJ/cm² | [Positive] | Ghosting | Density |
| Example | 1 | 0.11 | 0.9 | 8.182 | A | A |
| | 2 | 0.06 | 0.5 | 8.333 | A | A |
| | 3 | 0.13 | 0.4 | 3.077 | A | A |
| | 4 | 0.17 | 0.35 | 2.059 | A | A |
| | 5 | 0.14 | 1.4 | 10.000 | A | A |
| | 6 | 0.16 | 1.2 | 7.500 | A | A |
| | 7 | 0.06 | 0.7 | 11.667 | A | A |
| | 8 | 0.12 | 0.8 | 6.667 | A | A |
| | 9 | 0.11 | 1 | 9.091 | A | A |
| | 10 | 0.12 | 0.9 | 7.500 | A | A |
| | 11 | 0.11 | 0.8 | 7.273 | A | A |
| | 12 | 0.11 | 0.9 | 8.182 | A | A |
| Comparative | 1 | 0.14 | 1.8 | 12.857 | Positive | A |
| example | | | | | Ghosting | |
| | 2 | 0.22 | 0.33 | 1.500 | Negative | C |
| | | | | | Ghosting | |
| | 3 | 0.16 | 0.2 | 1.250 | Negative | A |
| | | | | | Ghosting | |
| | 4 | 0.19 | 0.4 | 2.105 | A | C |
| | 5 | 0.19 | 2.2 | 11.579 | Positive | C |
| | | | | | Ghosting | |
| | 6 | 0.25 | 2 | 8.000 | A | C |
| | 7 | 0.2 | 1.8 | 9.000 | A | C |
| | 8 | 0.19 | 1 | 5.263 | A | C |
| | 9 | 0.3 | 1.5 | 5.000 | A | C |

It can be seen from the above results that, when the Examples are compared to the Comparative Examples, the sensitivity of a photoreceptor during positive charging increases and superior image density is obtained; and furthermore superior results are obtained in the evaluation for ghosting.

Hereinafter, the abbreviations in Table 1 are shown in detail.

### Electron and Hole Transport Material

Electron transport material (1): Compound represented by Formula (2) (R¹¹ to R¹⁷: H, R¹⁸: C₇H₁₅)

Electron transport material (2): Compound represented by Formula (2) (R¹¹ to R¹⁷: H, R¹⁸: C₈H₁₇)

Electron transport material (3): Compound represented by Formula (2) (R¹¹ to R¹⁷: H, R¹⁸: C₅H₁₁)

Electron transport material (4): Compound represented by Formula (2) (R¹¹ to R¹⁷: H, R¹⁸: n-C₄H₉)

Electron transport material (5): Compound represented by Formula (2) (R¹¹ to R¹⁷: H, R¹⁸: n-C₁₁H₂₃)

Electron transport material (6): Compound represented by Formula (2) (R¹¹ to R¹⁷: H, R¹⁸: 2-ethylhexyl group)

Electron transport material (7): Compound represented by the following structure (X)

Compound 1: Hole transport material represented by the following structure

Compound 2: Hole transport material represented by the following structure (N,N′-diphenyl-N,N′-bis(3-methylphenyl)-[1,1′]biphenyl-4,4′-diamine)

### Binder Resin

PCZ: Bisphenol Z polycarbonate resin (viscosity average molecular weight: 50,000)

### Charge Generation Material

HOGaPC (V-type): V-type hydroxygallium phthalocyanine pigment having diffraction peaks at Bragg angles (2θ±0.2°) of at least 7.3°, 16.0°, 24.9°, and 28.9° in X-ray diffraction spectrum using CuKα characteristic X-rays (maximum peak wavelength in spectral absorption spectrum of wavelength range of from 600 nm to 900 nm=820 nm, average particle diameter=0.12 μm, maximum particle diameter=0.2 μm, specific surface area=60 m²/g)

ClGaPC: Chlorogallium phthalocyanine pigment having diffraction peaks at Bragg angles (2θ±0.2°) of at least 7.4°, 16.6°, 25.5°, and 28.3° in X-ray diffraction spectrum using CuKα characteristic X-rays (maximum peak wavelength in spectral absorption spectrum of wavelength range of from 600 nm to 900 nm=780 nm, average particle diameter=0.15 μm, maximum particle diameter=0.2 μm, specific surface area=56 m²/g)

H₂PC (x-type): Metal-free phthalocyanine pigment (phthalocyanine in which two hydrogen atoms are coordinated to center of phthalocyanine skeleton)

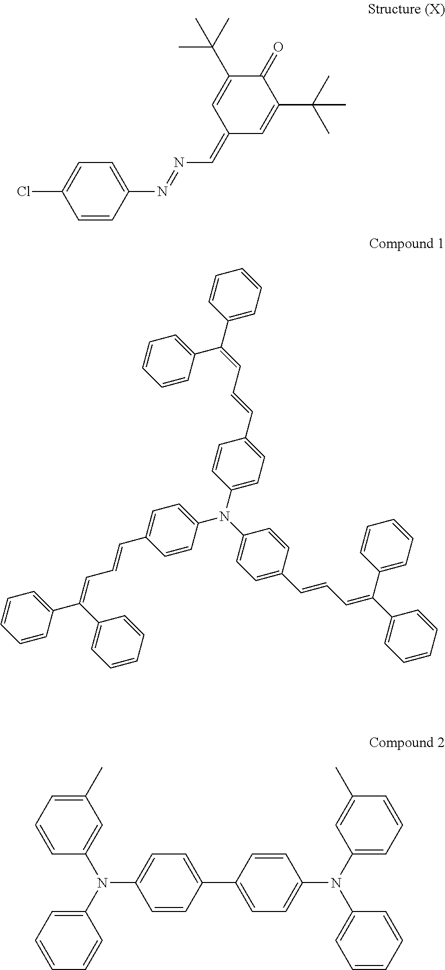 [SMILES: CC(C)(C)C1=CC(=C/N=N/c2ccc(Cl)cc2)C=C(C(C)(C)C)C1=O ; C(/C=C/c1ccc(N(c2ccc(/C=C/C=C(c3ccccc3)c3ccccc3)cc2)c2ccc(/C=C/C=C(c3ccccc3)c3ccccc3)cc2)cc1)=C(c1ccccc1)c1ccccc1 ; Cc1cccc(N(c2ccccc2)c2ccc(-c3ccc(N(c4ccccc4)c4cccc(C)c4)cc3)cc2)c1]

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate; and
a single-layer photosensitive layer that is provided on the conductive substrate and includes a binder resin, a charge generation material, a hole transport material, and an electron transport material,
wherein a half decay exposure during positive charging is less than or equal to 0.18 μJ/cm², and
a half decay exposure during negative charging is 2 times to 12 times the half decay exposure during positive charging.

2. The electrophotographic photoreceptor according to claim 1,
wherein the half decay exposure during positive charging is less than or equal to 0.14 μJ/cm².

3. The electrophotographic photoreceptor according to claim 1,
wherein the half decay exposure during positive charging is less than or equal to 0.11 μJ/cm².

4. The electrophotographic photoreceptor according to claim 1,
wherein the half decay exposure during negative charging is 4 times to 10 times the half decay exposure during positive charging.

5. The electrophotographic photoreceptor according to claim 1,
wherein the half decay exposure during negative charging is 5 times to 9 times the half decay exposure during positive charging.

6. The electrophotographic photoreceptor according to claim 1,
wherein the charge generation material is a V-type hydroxygallium phthalocyanine pigment.

7. The electrophotographic photoreceptor according to claim 1,
wherein the hole transport material contains a compound represented by Formula (1): 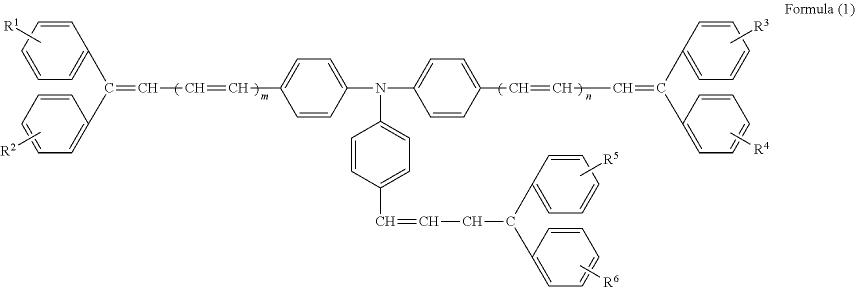
wherein in Formula (1), R¹, R², R³, R⁴, R⁵, and R⁶ each independently represent a hydrogen atom, a lower alkyl group, an alkoxy group, a phenoxy group, a halogen atom, or a phenyl group which may have a substituent selected from a lower alkyl group, an alkoxy group, and a halogen atom; and m and n each independently represent 0 or 1.

8. The electrophotographic photoreceptor according to claim 1,
wherein the electron transport material contains a compound represented by Formula (2): 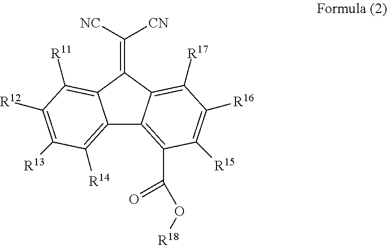
wherein in Formula (2), R¹¹, R¹², R¹³, R¹⁴, R¹⁵, R¹⁶, and R¹⁷ each independently represent a hydrogen atom, a halogen atom, an alkyl group, an alkoxy group, or an aryl group; and R¹⁸ represents an alkyl group.

9. The electrophotographic photoreceptor according to claim 1,
wherein a content of the charge generation material is from 3% by weight to 12% by weight with respect to a content of the binder resin.

10. A process cartridge, which is detachable from an image forming apparatus, comprising:
the electrophotographic photoreceptor according to claim 1.

11. An image forming apparatus comprising:
the electrophotographic photoreceptor according to claim 1;
a charging unit that charges the electrophotographic photoreceptor;
an electrostatic latent image forming unit that forms an electrostatic latent image on a charged electrophotographic photoreceptor;
a developing unit that accommodates a developer containing a toner and develops the electrostatic latent image,
formed on the electrophotographic photoreceptor, using the developer to form a toner image; and
a transfer unit that transfers the toner image onto a transfer medium.

12. The image forming apparatus according to claim 11,
wherein the image forming apparatus does not include an erasing unit that erases an outer peripheral surface of the electrophotographic photoreceptor, in a region which is located downstream of the charging unit in a driving direction of the electrophotographic photoreceptor and is located upstream of the transfer unit in the driving direction of the electrophotographic photoreceptor.

13. The image forming apparatus according to claim 11,
wherein the charging unit includes a charger that charges a surface of the electrophotographic photoreceptor without contact therewith.
